(19) United States
(12) Patent Application Publication
(10) Pub. No.: US 2012/0325513 A1
(43) Pub. Date: Dec. 27, 2012

(54) CONNECTOR ASSEMBLY HAVING STRAIN RELIEF FEATURE

(75) Inventors: Edward Martin Bungo, Dubois, PA (US); David John Geer, Johnsonburg, PA (US)

(73) Assignee: GENERAL ELECTRIC COMPANY, Schenectady, NY (US)

(21) Appl. No.: 13/167,217

(22) Filed: Jun. 23, 2011

(51) Int. Cl. H02G 15/08

(52) U.S. Cl. 174/89

(57) ABSTRACT

A connector assembly is provided having a cable having an outer jacket and inner shield, a cable clamp connected to the cable, and an eyelet. The eyelet has an elongated portion and flange. The flange includes a flange surface near the cable clamp to longitudinally position the eyelet relative to the cable. At least a portion of the elongated portion of the eyelet is crimped to the outer jacket of the cable to substantially prevent relative rotation between the cable and the eyelet.

### BACKGROUND OF THE INVENTION

The subject matter disclosed herein relates to a connector assembly, and more specifically to a connector assembly having a feature for providing torsional strain relief for a cable.

In some types of applications of a coaxial cable, a connector may be fastened to one or both ends of the coaxial cable. A braided or woven shield that is typically constructed from a conductive material such as, for example, copper is typically used to attach the coaxial cable to a connector housing. However, the woven shield can weaken or fray, which can result in the connector inadvertently disengaging from the coaxial cable. Weakening of the connection typically occurs during handling, installation, removal, or service of the coaxial cable and connector.

In one type of connector assembly, a portion of the braided or woven shield of the cable is stripped or unraveled and distributed circumferentially in a flared configuration around a face of a braid clamp. The flared portion of the woven shield is then trapped between the braid clamp and a connector housing. The flared portion of the woven shield is employed to clamp the coaxial cable between the connector housing and the braid clamp. Specifically, force may be exerted on the flared portion of the woven shield by a clamp nut. The force exerted by the clamp nut is used to secure and clamp the flared portion of the woven shield between the connector housing and the braid clamp. In one example, a washer and an O-ring are located between the braid clamp and the clamp nut, where the O-ring provides an environmental seal to protect the coaxial cable.

The coaxial cable may be twisted and pulled during assembly and servicing, which leads to torque and twisting forces being transmitted around the flared portion of the woven outer shield clamped between the connector housing and the clamp nut. Sometimes the flared portion of the woven shield is unable to withstand the twisting forces. Specifically, the twisting forces may weaken or even break the flared shield located between the connector and braid clamp, which leads to the coaxial cable separating from the connector. Therefore, it would be desirable to provide a more robust connection between the coax cable and the connector.

### BRIEF DESCRIPTION OF THE INVENTION

According to one aspect of the invention, a connector assembly is provided having a cable having an outer jacket and inner shield, a cable clamp connected to the cable, and an eyelet. The eyelet has an elongated portion and flange. The flange includes a flange surface that is near the cable clamp to position the eyelet relative to the cable. At least a portion of the elongated portion of the eyelet is crimped to the outer jacket of the cable to substantially prevent relative rotation between the cable and the eyelet.

According to another aspect of the invention, a connector assembly is provided having a cable having an outer jacket and inner shield, a cable clamp connected to the cable, and a ferrule. The cable clamp includes an inner tapered surface. The ferrule has a leading edge and a tapered outer surface. The tapered outer surface of the ferrule engages with the tapered inner surface of the cable clamp to cause the leading edge of the ferrule to engage with the outer jacket of the cable. Engagement of the outer jacket of the cable with the leading edge of the ferrule substantially prevents relative rotation between the cable and the ferrule.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is an view of a connector assembly in a partially assembled configuration;

FIG. 2 is an illustration of the connector assembly shown in FIG. 1 in another partially assembled condition;

FIG. 3 is a perspective view of a braid clamp shown in FIG. 1;

FIG. 4 is a cross-sectioned view of a crimp of the connector assembly shown in FIG. 1;

FIG. 5 is a cross-sectioned view of an alternative embodiment of a crimp of the connector assembly shown in FIG. 1;

FIG. 6 is a partially cross sectioned view of a portion of the connector assembly shown in FIG. 1;

FIG. 7 is a view of an alternative embodiment of a connector assembly in a partially assembled condition;

FIG. 8 is a perspective view of a braid clamp shown in FIG. 7;

FIG. 9 is another view of the connector assembly shown in FIG. 7;

FIG. 10 is yet another view of the connector assembly shown in FIG. 7; and

FIG. 11 is another view of the connector assembly shown in FIG. 7.

The detailed description explains embodiments of the invention, together with advantages and features, by way of example with reference to the drawings.

### DETAILED DESCRIPTION OF THE INVENTION

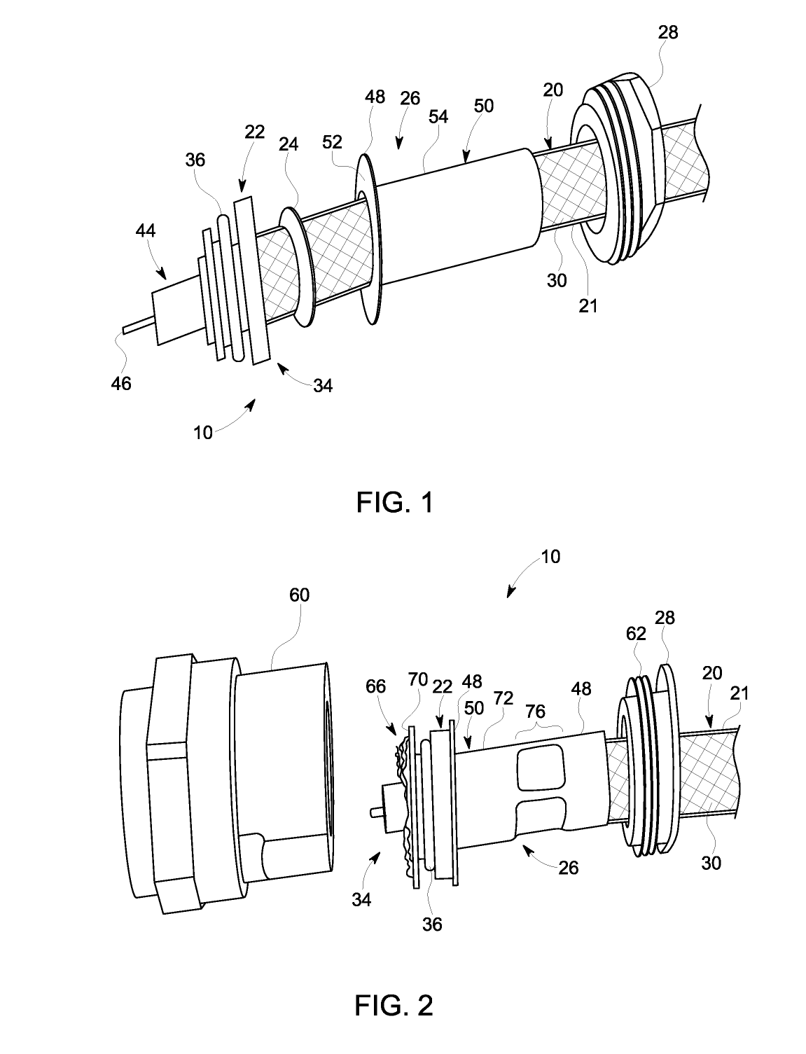

FIG. 1 illustrates a partially assembled view of an exemplary connector assembly indicated by reference number 10. The connector assembly 10 includes a cable 20, a cable or braid clamp 22, an O-ring 24, an eyelet 26, and a clamp nut 28. In the exemplary embodiment as shown, the cable 20 is a coaxial cable, however it is to be understood that other types of cables may be used as well. The cable 20 includes an outer jacket 21 and a braided or inner woven shield 30, which may be constructed from a metal based material that is an electrical conductor such as, for example, a copper alloy. The outer jacket 21 covers the inner woven shield 30 and is typically constructed from a plastic based material. In one exemplary embodiment, the connector assembly 10 is part of a sensor for a heavy machinery application, however it is to be understood that the connector assembly 10 may be used in a variety of applications.

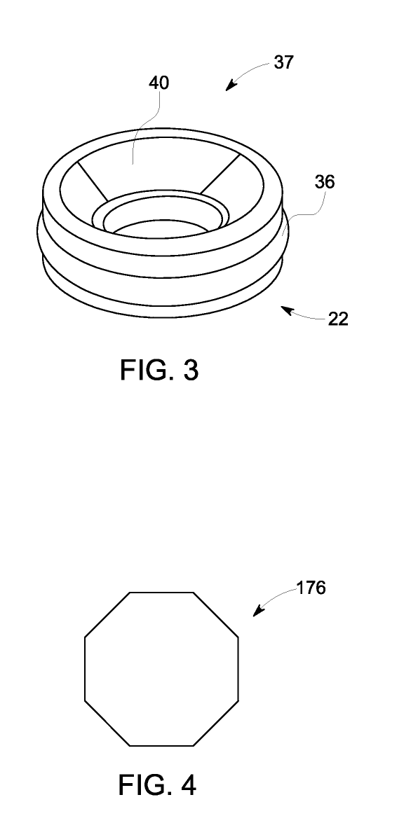

The braid clamp 22 is assembled to the cable 20 at an end portion 34 of the cable 20. The braid clamp 22 is connected to the cable 20 and is used to provide a face to rest a flared portion 66 of the inner woven shield 30 (shown in FIG. 2), which is discussed in greater detail below. The braid clamp 22 is also employed to provide positioning for a sealing ring, such as an O-ring 36 as well. The braid clamp 22 may rotate about the cable 20 until the connector assembly 10 is assembled, which is also discussed in greater detail below. Turning now to FIG. 3, which is an illustration of an underside portion 37 of the braid clamp 22, the braid clamp 22 includes a recessed portion 40. Referring to both FIGS. 1 and 3, the recessed portion 40 of the braid clamp 22 receives at least a portion of the O-ring 24 during assembly of the connector assembly 10. That is, the O-ring 24 fits inside the recessed portion 40 of the braid clamp 22 during assembly (the O-ring 24 fits inside the recessed portion 40 in FIG. 2). The O-ring 24 is used to provide an environmental seal and generally protects the cable 20. Specifically, in the embodiment as shown the O-ring 24 is used to protect a dielectric insulator 44 and a center core 46 of the cable 20 from environmental elements. Turning back to FIG. 1, the eyelet 26 includes a flange 48 and an elongated portion 50. The flange 48 of the eyelet 26 includes a flange surface 52 that abuts against a portion of the braid clamp 22 (abutment is shown in FIG. 2) during assembly of the connector assembly 10 to longitudinally position the eyelet 26 in relation to the cable 20.

FIG. 2 is an illustration of a partially assembled connector assembly 10, where the O-ring 24 is placed within the recessed portion 40 (shown in FIG. 3) of the braid clamp 22. The end portion 34 of the cable 20, the braid clamp 22, the O-ring 24 (shown in FIG. 1), and the flange 48 of the eyelet 26 are received by a connector housing 60 during assembly of the connector assembly 10. In the embodiment as shown, the clamp nut 28 includes a threaded outer surface 62, where the threaded outer surface 62 of the clamp nut 28 threadingly engages with a threaded inner surface (not shown) of the connector housing 60 during assembly, however it is to be understood that other approaches may be used as well to connect the clamp nut 28 to the connector housing 60.

A portion of the inner woven shield 30 is unraveled and arranged into a flared configuration that is the flared portion 66. The flared portion 66 of the inner woven shield 30 is positioned at the end portion 34 of the cable 20, and in one embodiment may be arranged in a circumferential arrangement with wires extending radially outwardly around the end portion 34 of the cable 20. Specifically, the flared portion 66 is positioned against an end surface 70 of the braid clamp 22. The flared portion 66 of the cable 20 is used to provide grounding to the housing 60. During assembly, the flared portion 66 of the inner woven shield 30 is placed between the end surface 70 of the braid clamp 22 and an inner surface (not shown) located within the connector housing 60. The clamp nut 28 fits over an outer surface 72 of the flange 48 of the eyelet 26 and threadlingly engages with the connector housing 60. In one embodiment, the clamp nut 28 is threadlingly engaged with the connector housing 60 at a torque of approximately 3.4 Nm, however it is to be understood that the clamp nut 28 may be torqued to the connector housing 60 at other forces as well depending on the application. The clamping nut 28 exerts a clamping force that compresses the flared portion 66 of the cable 20 between the braid clamp 22 and the connector housing 60, and secures the cable 20 between the connector housing 60 and the braid clamp 22.

FIG. 2 also illustrates at least a portion of the elongated portion 50 of the eyelet 26 crimped to the outer jacket 21. Crimping the elongated portion 50 of the eyelet 26 limits or substantially prevents relative rotation between the cable 20 and the eyelet 26. Specifically, a crimped connection 76 between the cable 20 and the eyelet 26 substantially prevents relative rotation between the cable 20 and the eyelet 26. The flange 48 of the eyelet 26 is clamped against the braid clamp 22 by the clamping nut 28. Specifically, referring to FIG. 6, the clamping nut 28 includes a first engagement surface 90, where the first engagement surface 90 abuts against a second engagement surface 92 of the flange 48 of the eyelet 26. During assembly of the connector assembly 10, the clamp nut 28 is threadingly engaged with the connector housing 60 (FIG. 2), thereby causing the first engagement surface 90 of the clamping nut 28 to compress against the second engagement surface 92 of the flange 48. The flange 48 of the eyelet 26 and the braid clamp 22 are both clamped between the clamp nut 28 and an inner surface of the connector housing 60 (not shown in FIG. 2). Thus, when the clamp nut 28 is engaged with the connector housing 60 (FIG. 2), relative rotation is also limited or prevented between the eyelet 26 and the clamp nut 28, the eyelet 26 and the braid clamp 22, and between the eyelet 26 and the connector housing 60. Moreover, in this configuration the braid clamp 22 is compressed between the clamp nut 28 and the connector housing 60 and is unable to rotate about the cable 20. The elongated portion 50 of the eyelet 26 is crimped to the cable 20, which in turn also substantially prevents relative rotation between the cable 20 and the clamp nut 28, and between the cable 20 and the connector housing 60.

Reducing or preventing relative rotation limits or prevents torque and twisting forces from being transmitted to the flared portion 66 of the inner woven shield 30 and also provides strain relief to the cable 20 as well. Specifically, referring back to FIG. 2, the cable 20 is sometimes twisted and pulled during assembly and service, which may lead to torque and twisting forces being transmitted around the flared portion 66 clamped between the connector housing 60 and the braid clamp 22. The twisting forces sometimes weaken or fray the flared portion 66 of the woven inner shield 30, which may eventually lead to the cable 20 separating from the connector housing 60. The crimped connection 76 between the cable 20 and the eyelet 26 is used to limit or substantially prevent the occurrence of twisting forces being transferred to the flared portion 66 of the woven inner woven shield 30.

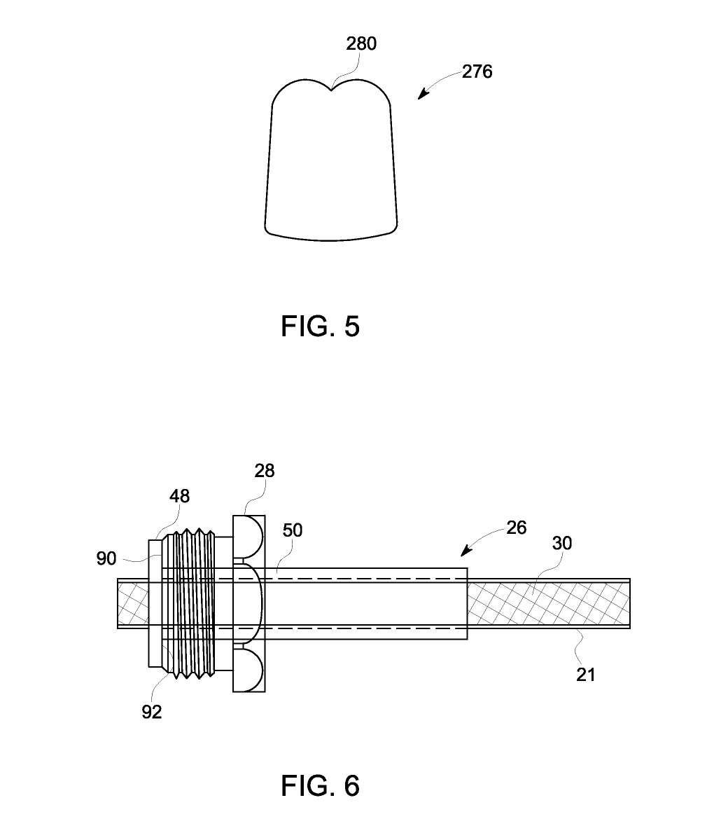

The elongated portion 50 can be crimped to the cable 20 using a variety of approaches. For example, FIGS. 4-5 are cross-sectioned views of exemplary crimped connections. The crimped connection 76 (FIG. 2) may be configured in either a hexagonal or an octagonal crimped configuration 176 which is shown in FIG. 4, or an F-crimp 276 which is shown in FIG. 5, however it is to be understood that other crimping configurations may be used as well. Referring to FIG. 5, an axial detent 280 which is created by the F-crimp 276 may enhance the retention capacity of the crimp 276. Referring back to FIG. 2, the eyelet 26 may facilitate use of a fixture (not shown) during assembly of the connector assembly 10, where the flared portion 66 of the inner woven shield 30 is compressed against the connector housing 60 in the fixture. Allowing the eyelet 28 to be placed in a fixture allows for an operator to compress the flared portion 66 of the inner woven shield 30 against the connector housing 60 with greater ease when compared to the operator attempting to compress the flared portion 66 against the connector housing 60 by hand without the use of a fixture.

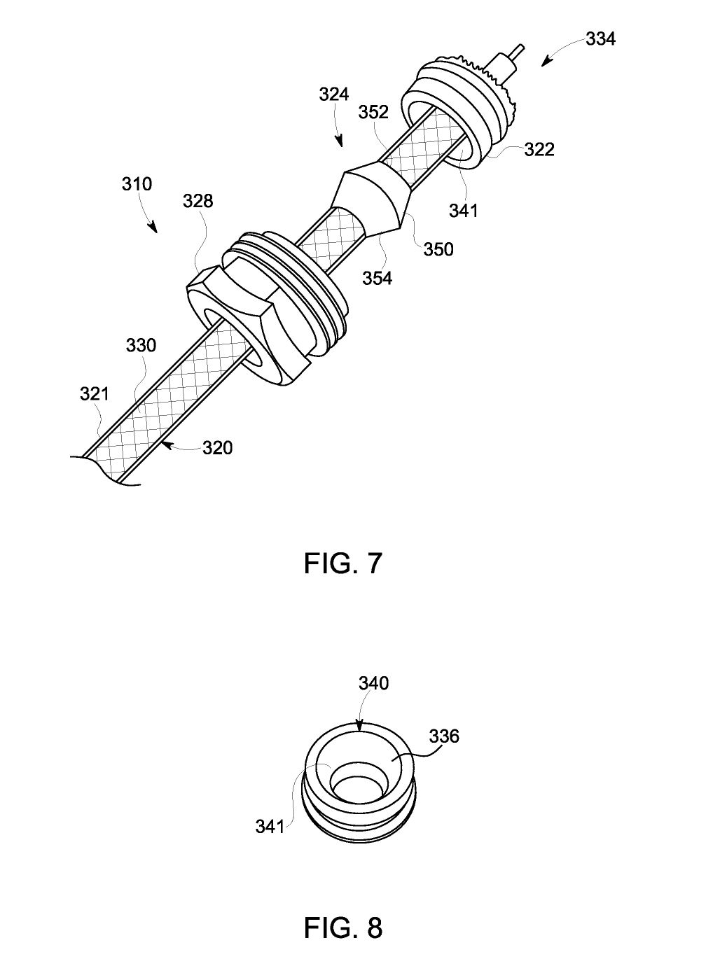

FIG. 7 illustrates another embodiment of a connector assembly 310. The connector assembly 310 includes a cable 320, a braid clamp 322, a ferrule 324, and a clamp nut 328. In the exemplary embodiment as shown, the cable 320 is a coaxial cable, however it is to be understood that other types of cables may be used as well. The cable 320 includes an outer jacket 321 and a braided or woven inner shield 330. The braid clamp 322 is assembled to the cable 320 at an end portion 334 of the cable 320. Turning now to FIG. 8, which is an illustration of an underside portion 336 of the braid clamp 322, the braid clamp 322 includes a recessed portion 340 having a tapered inner surface 341. Referring to both FIGS. 7-8, the tapered inner surface 341 of the braid clamp 322 engages with a tapered outer surface 350 of the ferrule 324. The engagement between the tapered inner surface 341 of the cable clamp 322 and the tapered outer surface 350 of the ferrule 324 compresses the ferrule 324 inwardly towards the outer jacket 321 of the cable 320, and causes a leading edge 352 of the ferrule 324 to engage with the outer jacket 321 of the cable 320.

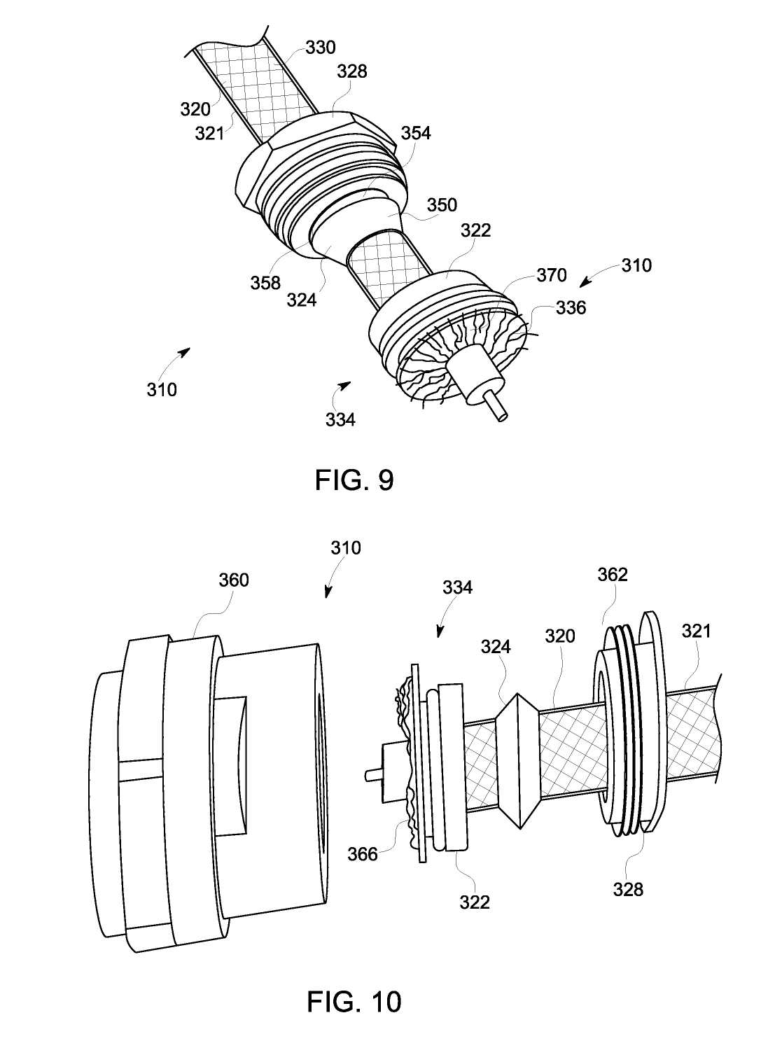

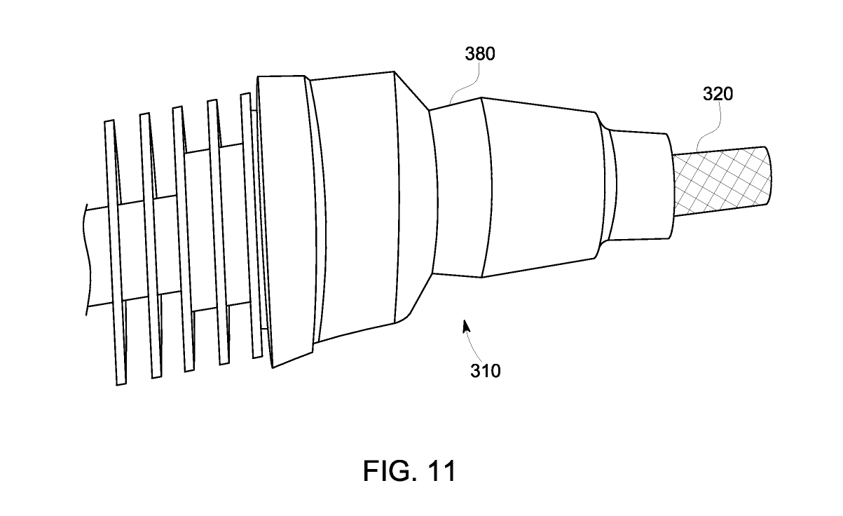

FIG. 9 is an illustration of a partially assembled connector assembly 310, where the ferrule 324 is received by the clamp nut 328. Specifically, referring to both of FIGS. 7 and 9, a second tapered outer surface 354 of the ferrule is received by an opening 358 located in the clamp nut 328. The second tapered outer surface 354 generally opposes and is angled in an opposing direction from the tapered outer surface 350. Referring to FIG. 10, the end portion 334 of the cable 320, the braid clamp 322, and the ferrule 324 are received by a connector housing 360 during assembly of the connector assembly 310. In the embodiment as shown, the clamp nut 328 includes a threaded outer surface 362, where the threaded outer surface 362 of the clamp nut threadingly engages with a threaded inner surface (not shown) of the connector housing 360 during assembly, however it is to be understood that other approaches may be used as well to connect the clamp nut 328 to the connector housing 360.

Referring back to FIG. 9, a portion of the woven inner woven shield 330 is unraveled and arranged into a flared configuration that is flared portion 366. The flared portion 366 of the woven inner woven shield 330 is positioned at the end portion 334 of the cable 320, and in one embodiment may be arranged in a circumferential arrangement around the end portion 334 of the cable 320. Specifically, the flared portion 366 is positioned against an end surface 370 of the braid clamp 322. During assembly, the flared portion 366 of the woven inner shield 330 is placed between the end surface 370 of the braid clamp 322 and an inner surface (not shown) located within the connector housing 360 (shown in FIG. 10). The clamping nut 328 exerts a clamping force which compresses the flared portion 366 of the cable 320 between the clamp nut 322 and the connector housing 360.

Referring to FIGS. 7 and 9, the engagement between the tapered inner surface 341 of the cable clamp 322 and the tapered outer surface 350 of the ferrule compresses the ferrule 324 inwardly towards the woven outer jacket 321 of the cable 320. This causes the leading edge 352 of the ferrule 324 to engage with the outer jacket 321 of the cable 320. Engagement of the leading edge 352 with the outer jacket 321 of the cable 320 substantially prevents relative rotation between the cable 320 and the ferrule 324. The tapered outer surface 350 of the ferrule 324 also engages with the tapered inner surface 341 (shown in FIGS. 7-8) of the cable clamp 322 as well, which limits relative rotation between the ferrule 324 and the cable clamp 322.

The second tapered outer surface 354 of the ferrule 324 is received by and engages with the opening 358 located in the clamp nut 328. The threaded engagement between the clamping nut 328 and the connector housing 360 compresses the ferrule 324, the cable clamp 322, and the flared portion 366 of the woven inner woven shield 330 of the cable 320 between the clamping nut 328 and an inner surface of the connector housing 360 (not shown) during assembly. The compression between the clamping nut 328 and the connector housing 360 limits relative rotation between the cable 320 and the ferrule 324 as well as between the ferrule 324 and the connector housing 360.

Reducing or preventing relative rotation between the cable 320 and the ferrule 324 will in turn also limit or prevent torque and twisting forces from being transmitted to the flared portion 366 of the cable 320. Specifically, the cable 320 is sometimes twisted and pulled during assembly and service, which leads to torque and twisting forces being transmitted around the flared portion 366. The twisting forces sometimes weaken or fray the flared portion 366, which eventually leads to the cable 320 separating from the connector housing 360. Engagement of the leading edge 352 of the ferrule 324 with the outer jacket 321 of the cable 320 limits or substantially prevents the occurrence of twisting forces being transferred to the flared portion 366 of the woven outer shield 330 of the cable 320.

FIG. 11 is an illustration of the connector assembly 310 with a flexible housing 380 covering at least a portion of the connector housing 360 (shown in FIG. 9), the cable 320, the cable clamp 322, the ferrule 324, and the clamp nut 328. The flexible housing 380 may be constructed from a pliable material that provides a barrier between moisture and contaminants. In one embodiment, the flexible housing 380 may be constructed from rubber. The flexible housing 380 is employed to substantially prevent ingression of contaminants and moisture into the inner portion of the connector housing 360.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A connector assembly, comprising:
a cable having an outer jacket and an inner shield;
a cable clamp connected to the cable; and
an eyelet having an elongated portion and flange, the flange including a flange surface near the cable clamp to longitudinally position the eyelet relative to the cable, and at least a portion of the elongated portion of the eyelet is crimped to the outer jacket of the cable to substantially prevent relative rotation between the cable and the eyelet.

2. The connector assembly of claim 1, wherein the inner shield is woven, and a portion of the inner shield has a flared configuration located at an end portion of the cable.

3. The connector assembly of claim 2, further comprising a connector housing that receives the cable clamp and the flared configuration of the inner shield, wherein the flared configuration of the inner shield is compressed between the cable clamp and the connector housing.

4. The connector assembly of claim 3, further comprising a clamp nut that is placed over an outer surface of the flange, wherein the clamp nut exerts a force that compresses the flared configuration of the inner shield between the cable clamp and the connector housing.

5. The connector assembly of claim 4, wherein the clamp nut includes a threaded outer surface and the connector housing includes a threaded inner surface, the threaded outer surface of the clamp nut is threadingly engaged with the threaded inner surface of the connector housing.

6. The connector assembly of claim 1, further comprising an O-ring that is located between the flange of the eyelet and the cable clamp, and wherein the O-ring is seated in a recess located in the cable clamp.

7. The connector assembly of claim 1, wherein the eyelet is crimped in one of a hexagonal configuration, an octagonal configuration, and an F-crimp configuration.

8. The connector assembly of claim 1, wherein the inner shield is electrically conductive.

9. A connector assembly, comprising:
a cable having an outer jacket and an inner shield;
a cable clamp connected to the cable and having an inner tapered surface; and
a ferrule having a leading edge and a tapered outer surface, the tapered outer surface of the ferrule engaging with the tapered inner surface of the cable clamp to cause the leading edge of the ferrule to engage with the outer jacket of the cable, and engagement of the outer jacket of the cable with the leading edge of the ferrule substantially prevents relative rotation between the cable and the ferrule.

10. The connector assembly of claim 9, wherein the inner shield is woven, and a portion of the inner shield has a flared configuration located at an end portion of the cable.

11. The connector assembly of claim 10, further comprising a connector housing that receives the cable clamp and the flared configuration of the inner shield, wherein the flared configuration of the inner shield is compressed between the cable clamp and the connector housing.

12. The connector assembly of claim 11, further comprising a clamp nut that is placed over an outer surface of the flange, wherein the clamp nut exerts a force that compresses the flared configuration of the inner shield between the cable clamp and the connector housing.

13. The connector assembly of claim 12, wherein the clamp nut includes a threaded outer surface and the connector housing includes a threaded inner surface, the threaded outer surface of the clamp nut is threadingly engaged with the threaded inner surface of the connector housing.

14. The connector assembly of claim 12, further comprising a flexible housing that is placed over at least a portion of the connector housing, the clamp nut, the cable clamp, and the cable.

15. The connector assembly of claim 12, wherein the ferrule includes another tapered outer surface, and wherein the other tapered outer surface is received by a recess located within the clamp nut.

16. The connector assembly of claim 1, wherein the inner shield is electrically conductive.

17. A connector assembly, comprising:
a cable having an outer jacket and an inner woven shield having a flared configuration located at an end portion of the cable;
a cable clamp connected to the cable;
a connector housing that receives the cable clamp and the flared configuration of the inner woven shield, the flared configuration of the inner woven shield compressed between the cable clamp and the connector housing; and
an eyelet having an elongated portion and flange, the flange including a flange surface that abuts against the cable clamp to longitudinally position the eyelet relative to the cable, and at least a portion of the elongated portion of the eyelet is crimped to the outer jacket of the cable to substantially prevent relative rotation between the cable and the eyelet.

18. The connector assembly of claim 17, further comprising a clamp nut that is placed over an outer surface of the flange, wherein the clamp nut exerts a clamping force that compresses the flared configuration of the inner woven shield between the cable clamp and the connector housing.

19. The connector assembly of claim 18, wherein the clamp nut includes a threaded outer surface and the connector housing includes a threaded inner surface, the threaded outer surface of the clamp nut is threadingly engaged with the threaded inner surface of the connector housing.

20. The connector assembly of claim 17, wherein the eyelet is crimped in one of a hexagonal configuration, an octagonal confirmation, and an F-crimp configuration.
